(19) United States
(12) Patent Application Publication
(10) Pub. No.: US 2001/0056462 A1
(43) Pub. Date: Dec. 27, 2001

(54) Method for starting application programs and software product for starting application programs

(76) Inventor: Katsuhisa Kataoka, Sagamihara-shi (JP)

Correspondence Address: Ronald L Drumheller, Esq., 94 Teakettle Spout Road, Mahopac, NY, 10541, US

(21) Appl. No.: 09/757,065

(22) Filed: Jan. 8, 2001

(30) Foreign Application Priority Data
Jan. 6, 2000 (JP) 2000-001043

(51) Int. Cl. G06F 15/16; G06F 15/177

(52) U.S. Cl. 709/203; 709/221

(57) ABSTRACT

By merely performing simple operations, an operating environment for an application program is prepared and the application program started. An applet capable of being distributed easily on an internet is used as a bootstrap to start an application program which is adapted to operate directly on the OS on which an associated browser is operating. In one aspect of this invention, the applet not only merely downloads code of an application program but also judges whether the application program code is cached or not in a local file system, checks the execution environment, checks for prerequisite software, and checks the version thereof. If the application program code is cached in the local file system, the application program is not downloaded. If any prerequisite software is not present, the prerequisite software is downloaded and the application program is started.

### DESCRIPTION

1. Field of the Invention

The present invention relates to an application program starting method and more particularly to a method for starting an application program loaded from a server on a client machine.

2. Related Art

According to a conventional method, a link to an execution file (“exe.file”) of an installer is put directly on a web page and a user is allowed to execute operations directly, thereby introducing application programs into a local computer. In this conventional method, however, the user is required to judge which package is to be executed in the case where the package to be introduced differs depending on platform or conditions and is also required to identify a premise software. Thus, the initial starting operation has so far been complicated.

On the other hand, an applet can be distributed easily, but involves a limitation that an applet operates in a browser. There is an applet authenticated by an authentication organ as a third party, which is called “signed applet,” but even if the limitation of security for the applet with signature is removed, there still remain limitations such as the user cannot control follow-up to changes in window size or termination. Besides, in case of using plural applets with signature, there also arises the problem that the management of their digital signatures becomes difficult.

A related prior art is Published Unexamined Patent Application No. 9-167085. According to the method disclosed in this unexamined publication, when a user acquires a desired group of programs automatically from a network, the user receives from a server computer a script describing an acquisition procedure and then acquires the program group in accordance with that procedure. As to programs already present in a client computer, they are not acquired from the server computer.

### SUMMARY

It is an object of the present invention to provide a computer system requiring only simple operations and thereby capable of preparing for an application program execution environment automatically and executing the application program.

It is another object of the present invention to provide a computer system capable of executing predetermined application programs even without detailed knowledge of the computer on the user side.

It is a further object of the present invention to make it possible to use an applet only at the time of starting an application program, start an application program capable of being executed locally after the acquisition and introduction of application programs from a server, and thereby attain an easy and fast start-up of application programs present on the server.

In this invention, an applet which can be distributed easily on an internet is used as a bootstrap, and an application program adapted to operate directly on the OS for operation of the associated browser is started. In one aspect of this invention, the applet not only downloads the code of an application program but also judges whether it is cached or not in a local file system, further, checks if another software program as a prerequisite, as well as any version thereof, is present or not. If the application program is cached in the local file system, the application program is not downloaded. If another software program as a prerequisite is not present, that software program is downloaded and the application program is started.

According to this invention, in one aspect thereof, there is provided a method for starting an application program loaded from a server on a client machine, comprising the steps of:

(a) loading an execution environment identifying applet from the server in response to an application program starting request made on client machine;

(b) loading from the server a code which the application program to be started on the client machine requires and a starting command for starting the application program, on the basis of a result obtained by executing the execution environment identifying applet; and

(c) executing the starting command on the client machine and thereby starting the application program.

In claims described in the specification of the present application, “the server which loads an application program,” “the server which loads an execution environment identifying applet,” and “the server which loads a code which the application program requires and also loads a starting command for starting the application program,” may be the same server or different servers. The “code which the application program requires” is of a concept including not only the code of the application program itself but also incidental codes required in the execution of the application program.

In another aspect of the present invention there is provided a method for starting an application program loaded from a server on a client machine, comprising the steps of:

(a) loading from the server a code which the application program to be started on the client machine requires and a starting command for starting the application program, in response to an application program starting request made on the client machine; and

(b) executing the starting command on the client machine and thereby starting the application program.

In a further aspect of the present invention there is provided any of the above methods, further comprising the step of judging whether the code which the application program requires is present or not on the client machine, wherein, with respect to the code which the application program requires and the starting command for starting the application program, the code which the application program requires is loaded from the server when the code which the application program requires is not present on the client machine.

In a still further aspect of the present invention there is provided a software product for starting an application program loaded from a server on a client machine, comprising:

(a) an execution environment identifying software for identifying an execution environment from the server in response to an application program starting request made on the client machine;

(b) a required code acquiring software for acquiring a code which the application program to be started on the client machine requires; and

(c) an application program starting software for executing a starting command for starting the application program on the client machine and thereby starting the application program.

In a still further aspect of the present invention there is provided a software product for starting an application program loaded from a server on a client machine, comprising:

(a) a required code acquiring software for loading from the server a code which the application program to be started on the client machine requires and a starting command for starting the application program, in response to an application program starting request made on the client machine; and

(b) an application program starting software for executing the starting command on the client machine and thereby starting the application program.

In a still further aspect of the present invention there is provided any of the above software products, wherein the required code acquiring software has a function of judging whether the code which the application program requires is present or not on the client machine.

### BRIEF DESCRIPTION OF THE DRAWINGS

FIG. 1 is a block diagram showing an example of a hardware configuration of an information terminal or a server according to this invention;

FIG. 2 is a functional block diagram showing processing elements of a computer system in a preferred embodiment of this invention;

FIG. 3 is a conceptual diagram showing a data structure of historical information in a preferred embodiment of this invention;

FIG. 4 is a conceptual diagram showing a data structure of a local environment identifying information in a preferred embodiment of this invention;

FIG. 5 is a conceptual diagram showing a data structure of an application program starting information in a preferred embodiment of this invention;

FIG. 6 is a flow chart showing a processing procedure in a preferred embodiment of this invention;

FIG. 7 is a flow chart showing a main operation procedure of a local environment identifying logic in a preferred embodiment of this invention;

FIG. 8 is a flow chart showing a main operation procedure of a required code introducing logic in a preferred embodiment of this invention; and

FIG. 9 is a conceptual diagram showing a web browser display in a preferred embodiment of the present invention with a bootstrap applet loaded.

### DESCRIPTION OF THE PREFERRED EMBODIMENT

A. Hardware Configuration

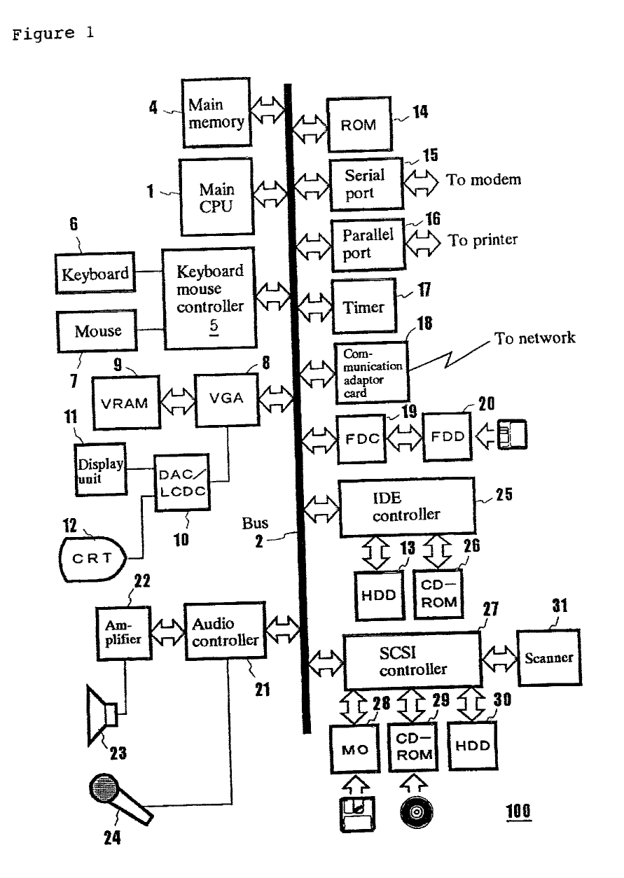

FIG. 1 is a schematic diagram of a hardware configuration for implementing an information terminal 110 or a server 150, both being constituents of a computer system 100 according to this invention. The information terminal 110 or the server 150 includes a central processing unit (CPU) 1 and a memory 4. The CPU 1 and the memory 4 are connected to hard disk units 13 and 31 as auxiliary memories through a bus 2, etc. A floppy disk unit 20 (or medium drives such as MO 28, CD-ROMs 26, 29, and HDD 30) is connected to the bus 2 through a floppy disk controller 19 (or various controllers, including IDE controller 25 and SCSI controller 27).

A floppy disk (or such a medium as MO or CD-ROM) is inserted into the floppy disk unit 20 (or such a medium drive as MO 28, CD-ROM 26, 29, or HDD 30). Into such storage mediums as the floppy disk, hard disk unit 13, and ROM 14 there can be recorded codes of computer program for issuing instructions to the CPU, etc. in cooperation with the operating system and for practicing the invention, which programs are executed by being loaded into the memory 4. It is also possible to compress the computer program codes or divide each of them into plural portions for recording over a plurality of mediums.

The information terminal 110 or the server 150 may be configured as a system provided with user interface hardware. As examples of user interface hardware there are mentioned a pointing device (e.g. mouse, joy stick, or track ball) 7 for the input of display position information, a keyboard 6 for supporting key input, and displays 11 and 12 for the display of image data to the user. A speaker 23 receives an aural signal from an audio controller 21 through an amplifier 22 and outputs it as voice.

The information terminal 110 or the server 150 can make communication with other computers or communication satellites through a serial port 15 or a communication adapter 18 such as a modem or a token ring.

The present invention can be practiced by any or a combination of ordinary personal computers (PC), computers incorporated in work stations or in various home electric appliances such as TV and FAX, and computers (e.g. car navigation systems) mounted on vehicles or aircraft. But these constituent elements are illustrative and it is not that all of them are essential to this invention. Particularly, since the present invention is concerned with an application program starting method, such constituent elements as the speaker 23, audio controller 21 and amplifier 22 are not essential in one aspect of this invention.

The operating system in the information terminal 110 can be any of those which support GUI multi-window environment in a standard mode such as WindowsNT (trademark of Microsoft Corporation), Windows9x (trademark of Microsoft Corporation), Windows3.x (trademark of Microsoft Cooperation), OS/2 (trademark of IBM Corporation), MacOS (trademark of Apple Co.), Linux (trademark of Linus Torvlds), and X-WINDOW system (trademark of MIT) on AIX (trademark of IBM Corporation), those supporting a character-base environment such as PC-DOS (trademark of IBM Corporation) and MS-DOS (trademark of Microsoft Corporation), real-time OSs such as OS/open (trademark of IBM Cooperation) and VxWorks (trademark of Wind River Systems, Inc.), and those incorporated in network computers such as JavaOS. Thus, no limitation is made to any specific operating system environment.

As the operating system in the server 150, any of those which support GUI multi-window environment in a standard mode are preferred, such as WindowsNT (trademark of Microsoft Cooperation), Windows9x (trademark of Microsoft Cooperation), Windows3.x (trademark of Microsoft Cooperation), OS/2 (trademark of IBM Cooperation), MacOS (trademark of Apple Co.), Linux (trademark of Linus Torvlds), and X-WINDOW system (trademark of MIT) on AIX (trademark of IBM Cooperation). However, the OS in question may be even any of those which support a character-base environment such as PC-DOS (trademark of IBM Cooperation) and MS-DOS (trademark of Microsoft Cooperation), and those incorporated in network computers such as JavaOS. Thus, there is made no limitation to any specific operating system environment.

B. System Configuration

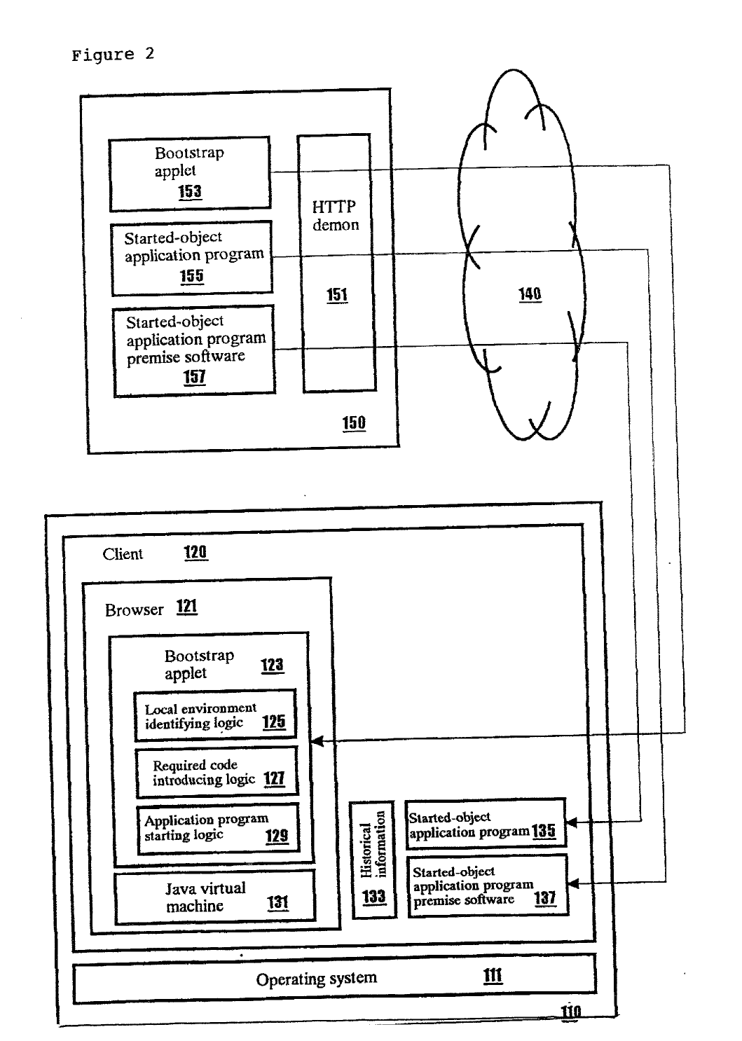

FIG. 2 is a functional block diagram showing processing elements used in a computer system according to a preferred embodiment of this invention. The computer system, indicated at 100, includes an information terminal 110 and a server 150.

In the information terminal 110 there exist an operating system 111 and a client environment 120 adapted to operate on the operating system 111. A web browser 121 is introduced into the client environment 120, which can be operated on a Java virtual machine 131 by acquiring a bootstrap applet 123 from the server 150 through a network 140.

The information terminal 110 has a historical information 133, a started-object application program 135, and a started-object application program premise software 137. The started-object application program 135 and the started-object application program premise software 137 are downloaded from the server 150 by a function of the present invention which will be described later.

In a preferred embodiment of this invention, a local environment identifying logic 125, a required code introducing logic 127, and an application program starting logic 129 are included in the bootstrap applet 123 which is downloaded from the server 150.

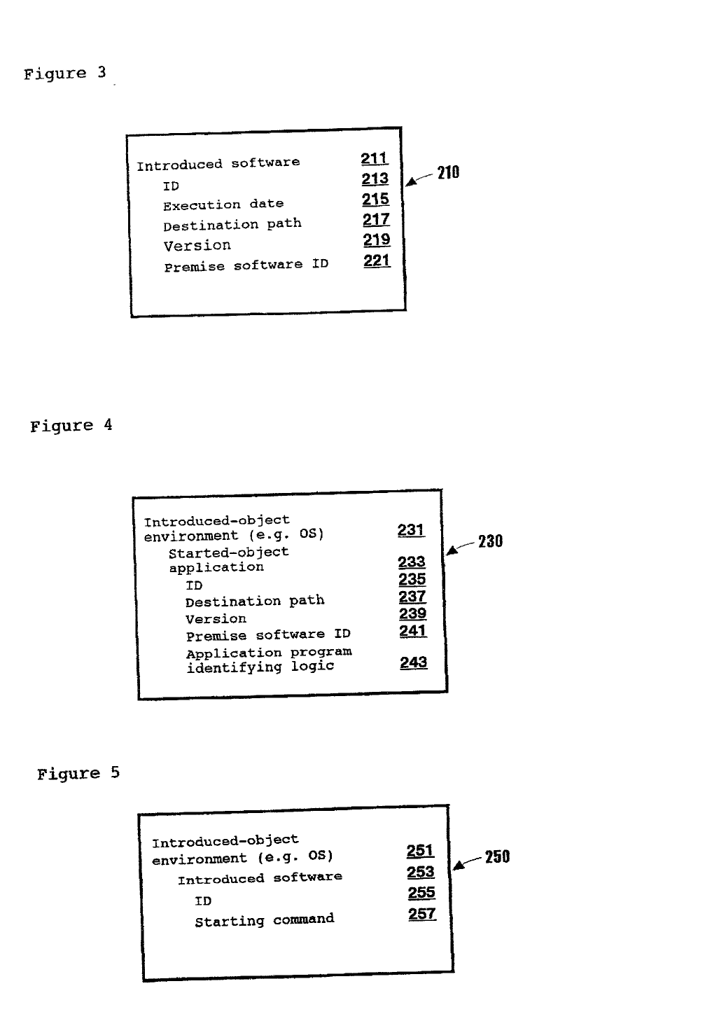

The local environment identifying logic 125 holds a local environment identifying information shown in FIG. 4, determines a code to be introduced, while making reference to historical information, and instructs the required code introducing logic 127 to introduce the code if the code is present. If the code to be introduced is not present, the local environment identifying logic 125 instructs the application program starting logic 129 to start the application program.

FIG. 3 is a conceptual diagram showing a data structure of historical information used in a preferred embodiment of this invention. In the historical information, indicated at 210, are included information pieces of introduced software name 211, software ID 213, introduction date 215, destination path name 217, version information 219, and premise software ID 221. The information pieces of software ID 213, introduction date 215, destination path name 217, version information 219, and premise software ID 221 are registered in correspondence to the introduced software name 211. The introduced software name 211 may be registered in a plural number.

By the introduced software name 211 is meant other software names such as application programs, e.g. “Excel” and “Word” (both are trademarks of Microsoft Cooperation), and a dynamic link library. The software ID 213 is an identifier peculiar to the software concerned in the computer system 100. The introduction date 215 is an information piece of the software introduced date. The destination path name 217 is a path information for access to the software, such as “c:\windows.” The version information 219 is a version information of the software. The premise software ID 221 is an information piece for specifying a software which is necessary for operation of the software concerned.

FIG. 4 is a conceptual diagram showing a data structure of a local environment identifying information in a preferred embodiment of this invention. In the local environment identifying information, indicated at 230, are included information pieces of introduced-object environment information 231, started-object application program name 233, application program ID 235, destination path name 237, version information 239, premise software ID 241, and application program identifying logic. The information pieces of software ID 235, destination path name 237, version information 239, premise software ID 241, and application program identifying logic 243, are registered in correspondence to an introduced software name 233. The introduced software name 233 can be registered plurally relative to the introduced-object environment information 231, which can also be registered plurally.

The introduced-object environment information 231, say, “windows 98” or “MacOS” (“windows 98” is a trademark of Microsoft Cooperation and “MacOS” is a trademark of Apple Co.) is for specifying an application program operating environment. The introduced application program name 233 is the name of an application program such as “Excel” or “Word” (both are trademarks of Microsoft Corporation). The application program ID 235 is an identifier peculiar to the software concerned in the computer system 100. The destination path name 237 is a path information for access to the application program such as “c:¥windows.” The version information 239 is a version information of the application program. The premise software ID 241 is an information piece for specifying a software which is necessary for operation of the application program. The application program identifying logic 243 is an information piece such as a command for confirming the presence of the application program.

For example, it is here assumed that the following data are registered in the historical information 133:

| | |
|---|---|
| Introduced software name | JRE 1.2.2 |
| ID | 100 |
| Introduction date | 2000/01/01 |
| Destination path | c:¥Program Files¥JavaSoft¥jre¥l.2.2 |
| Version | 1.2.2 |
| Premise software ID | none |

To check the presence of the JRE 1.2.2, an identification command (e.g. script, pseudo code) like the following command for example is executed:

“execute “java -version”; (execute java -version).”.

If the software has already been introduced, a character string of “java version “1.2.2”” is returned. The following command is also issued to check the version:

“parseVersion “java version\“{0}\””; (Make sure of a response character string)”.

In the event of failure in parse, there returns the result of identification failure. Then, whether a desired version is present or not can be checked by “if (version>=“1.2.2”) return ok; (Return is OK if version is not less than 1.2.2)”, “else return bad;”.

Now, it is here assumed that the following data are registered in the historical information 133:

| Introduced software name | BAP 1.0 |
|---|---|
| ID | 200 |
| Introduction date | 2000/01/01 |
| Destination path | c:\BAP |
| Version | 1.0 |
| Premise software ID | 100 |

The presence of the BAP 1.0 can be checked using, for example, the following identification command:

“cd$ (PATH200); (shift to the ID200 directory of the destination path in the historical information),

“execute “java -classpath bap.jar com.ibm.apst.bap.Version” (Response is a return of the character string BAP 1.0 if the software has already been introduced)”.

For the confirmation of version there issues the following as in the foregoing example:

“parseVersion “BAP {0}”;”,

“if (version>=“1.0”) return ok;”,

“else return bad;”

The required code introducing logic 127 acquires a required set of software name, software ID, destination path information, and version information from the local environment identifying logic 125 and sends to the server 150 a request for acquiring the software. Further, the required code introducing logic 127 registers the acquired software on the basis of destination path information and confirms the registration. The application program starting logic 129 starts the application program and confirms the starting. In a preferred embodiment of this invention, signatures of an authentication organ are included in the bootstrap applet and the introduced software. By making a setting on the user side to cancel the security check for software programs which include signatures of the authentication organ in a browser for example, the software introducing operation is executed with maintaining the security but without performing any complicated confirming operation.

FIG. 5 is a conceptual diagram showing a data structure of an application program starting information in a preferred embodiment of this invention. In the application program starting information, indicated at 250, are included information pieces of introduced-object environment information 251, introduced application program name 253, application program ID 255, starting command 257, and starting identifying logic 259. The information pieces of application program ID 255, starting command 257, and starting identifying logic 259 are registered in correspondence to the introduced software name 253. The introduced software name 253 can be registered plurally for the introduced-object environment information 251, which also can be registered plurally.

The introduced-object environment information 231, like the local environment identifying information, is for specifying an environment in which an application program such as “windows98” and “MacOS” operates. The introduced application program name 253 is such an application me as “Excel” or “Word” (both are trademarks of Microsoft Corporation). The application program ID 235 is an identifier peculiar to the software concerned in the computer system 100. The starting command 257 is an information piece of a command for starting the application program. The starting identifying logic 259 is an information piece such as a command to check whether the application program has been normally started or not.

In starting the foregoing BAP 1.0 shown in the previously described example, the following starting command (e.g. script, pseudo code) can be executed:

“cd$ (PATH200); (shift to the ID200 directory of the destination path in the historical information)”,

“execute “java -classpath bap.jar com.ibm.apst.bap.BAP data¥Start.xml””

To confirm the starting of BAP 1.0, the following starting identifying command (e.g. script, pseudo code) can be executed after execution of the above starting command:

“findString “BAP Started” till 30 sec; (Make sure of a character string of BAP Started at a standard output within 30 seconds. If impossible, return a failure.)”,

“process running; (The started process has not been completed yet. If it has been completed, return a failure.)”

“return ok;”.

C. Processing Procedure

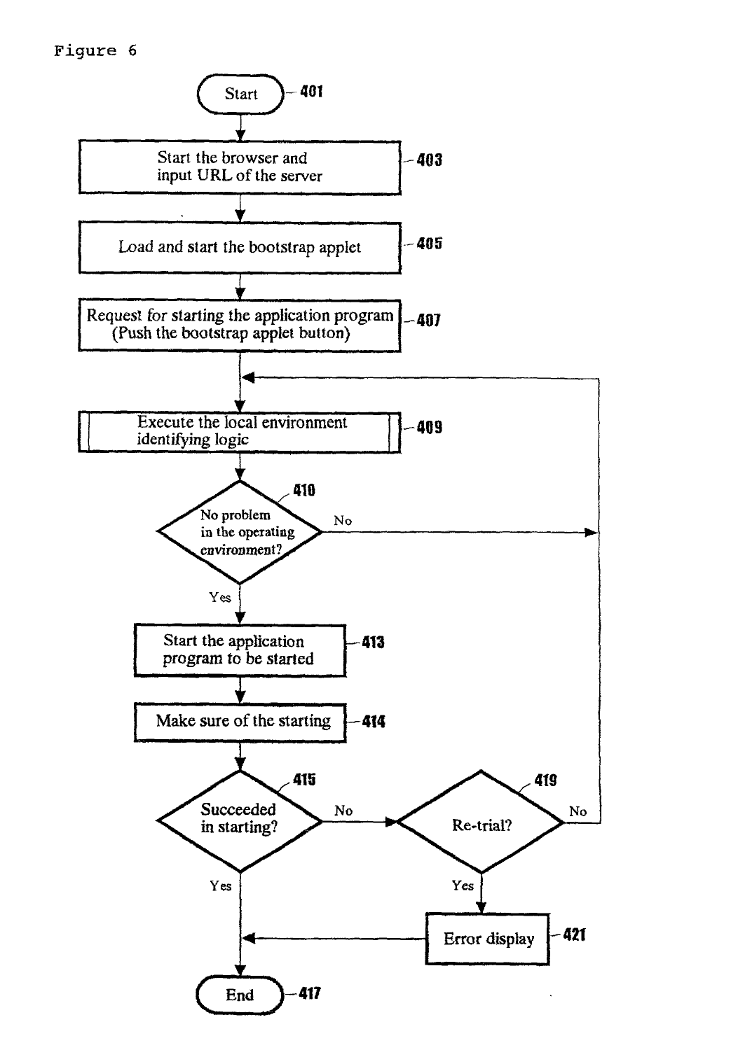

The processing procedure according to the present invention will be described below with reference to the flow chart of FIG. 6.

First, in the client environment 120, the user starts the web browser 121 and inputs URL of the server 150 (step 403), whereby the bootstrap applet 123 is loaded (step 405).

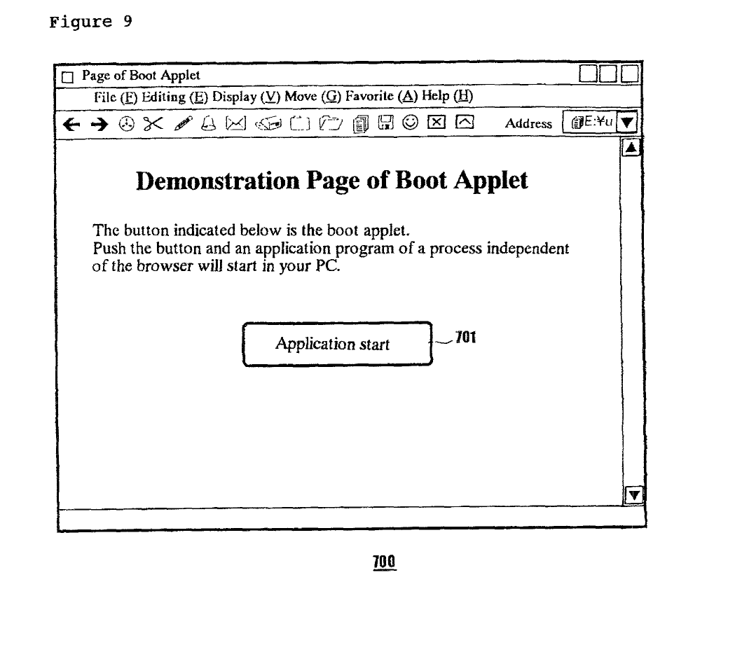

FIG. 9 is a conceptual diagram showing a web browser display in a loaded state of the bootstrap applet 123 according to a preferred embodiment of this invention. In this state, as shown in the same figure, an application program starting button 701 is disposed on the web browser display indicated at 700.

Preferably, for the simplification of explanation, codes of the local environment identifying logic 125, the required code introducing logic 127, and the application program starting logic 129 are loaded simultaneously with depression of the application program starting button 701. However, loading of the codes need not always be simultaneous with clicking of the button 701. For example, there may be adopted a method wherein information for access to each of the codes is embedded in the bootstrap applet 123 which is loaded simultaneously with depression of the button 701, and is acquired for each or a predetermined combination of the codes from the server 150 or another server during or before the execution of each code.

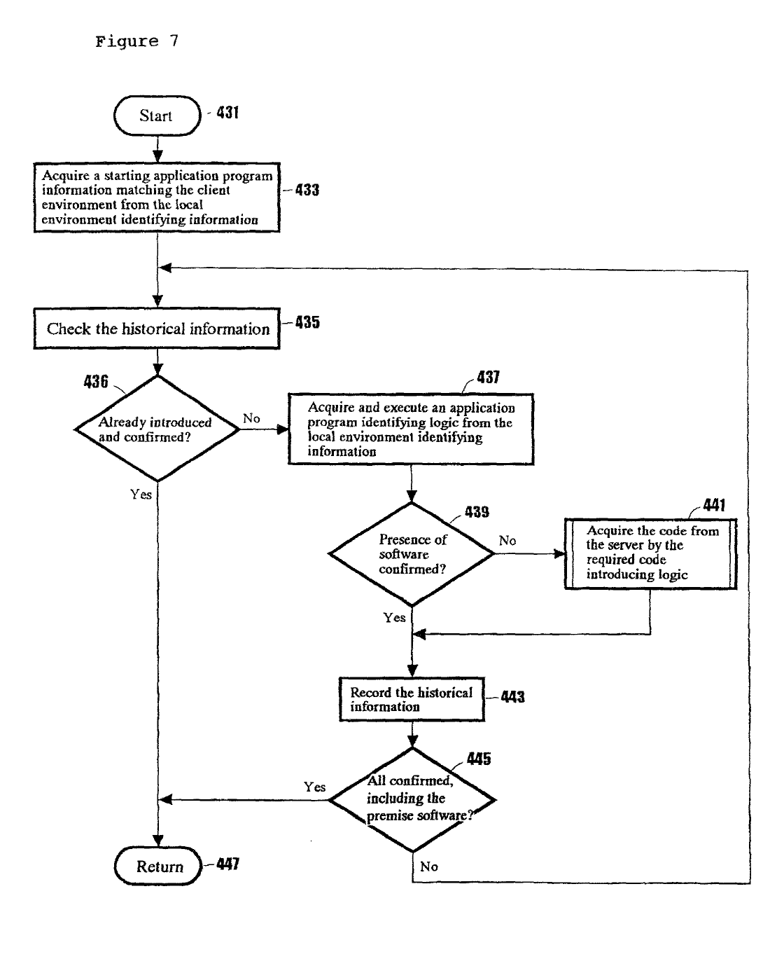

When the user pushes the application program starting button 701 to request starting of an application program (step 407), the local environment identifying logic 125 starts (step 409). FIG. 7 is a flow chart showing a main operation procedure of the local environment identifying logic. In one aspect of the present invention it is possible to let the user set, for example, an application program destination before requesting the starting of the application program.

First, the local environment identifying logic 125 checks the type of the operating system 111 in the information terminal 110, decides a starting application program corresponding to the operating system registered in the local environment identifying information 230 (FIG. 4), and acquires related information pieces 233˜243 (step 443). The operating system 111 in the information terminal 110 can be identified by making reference to the system property of Java or the agent name of HTTP request.

Next, the local environment identifying logic 125 makes access to the historical information 210 (FIG. 3) and judges on the basis of, say, application program name, ID, and version whether the started-object application program 233 and the premise software 241 have all been already introduced or not (step 435). If the answer is affirmative (step 436), the processing flow is returned to that shown in FIG. 6 (step 447). On the other hand, if it is judged that a software not introduced yet (including version disagreement) is present, the local environment identifying logic 125 acquires the software identifying logic 243 from the local environment identifying information 230 (FIG. 4) and executes it (step 437).

More specifically, by issuing the foregoing identifying command and checking the presence of software and a version thereof on the basis of a returned message, or by searching for a predetermined dynamic link library and making reference to the contents thereof, it is possible to acquire such information pieces as the presence of a predetermined software and a version information thereof. Consequently, it is possible to effectively utilize software programs already present in the information terminal 110 though not registered in the historical information 210.

If the presence of an employable and effective software program is not confirmed in the information terminal 110 and if it is judged that the introduction of a required code is necessary, the required code introducing logic 127 is executed to acquire the required code from the server 150 or another server (step 441).

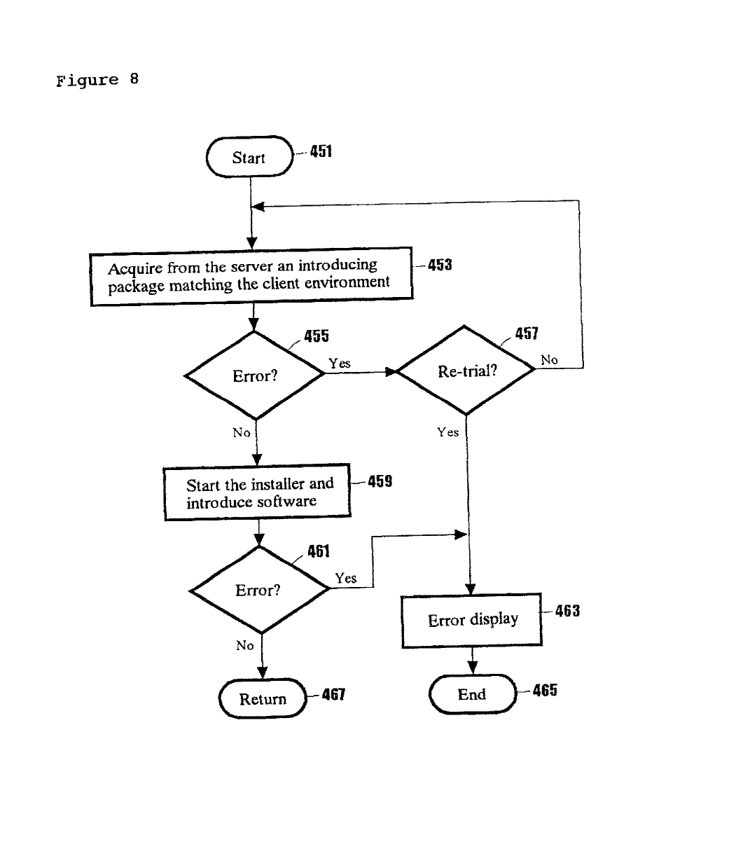

FIG. 8 is a flow chart showing a main operation procedure of the required code introducing logic. Once the required code introducing logic is started, a package for introducing the required software is acquired from the server 150 or another server. If the acquisition of the package from the server is not normally completed, re-trial is performed a predetermined number of times, and if the acquisition of the package could not be normally completed nevertheless, there is made an error display and the processing is ended (steps 455, 457, 463, and 465). If the package acquiring processing has been normally completed, the installer is started to introduce the software (step 459). If the introduction of the software has not been normally completed, an error display is made and the processing is ended (steps 461, 463, and 465). If the software introducing processing has been normally completed, the processing flow is returned to FIG. 7 (step 467).

A concrete example will now be introduced. For example, if the package of BAP 1.0 (ID 200) is not present, the bootstrap applet inquires URL of the server and acquires ftp: bootapplet.host/applications/BAP10.exe. Then, the bootstrap applet downloads BAP10.exe to an appropriate local directory, c:\BAPPLET\DOWNLOAD.

In this example, the acquired BAP10.exe is a self-uncompressing-type compressed file, and upon execution of BAP10.exe there appears an introducing package which includes an installer. As this introducing package there may be utilized, for example, a package fabricated by Install Shield (“Install Shield” is a trademark of Install Shield Software Corporation).

Then, the thawed installer is started. For example, in case of utilizing the above “Install Shield,” setup.exe is started by specifying a response file in a silent mode. (setup-s-f1Response.iss). Thereafter, the thawed, unnecessary file is erased. To the Install Shield is attached an introducing package fabricating tool which can effect thawing, execution of the installer and erasing of the file by merely starting the BAP10.exe.

If the presence of an employable and effective software in the information terminal 110 has been confirmed in step 439 or if the introduction of the necessary software has been normally completed in step 441, this information is recorded in the historical information 210 (step 443). If the introduction of all the software programs, including the premise software, has been confirmed, the processing flow is returned to the flow of FIG. 6 (step 447). If the introduction of a further software is needed, the processing flow is returned to step 435.

When the processing of step 409 in FIG. 6 is over, an object application program is started (step 413). More specifically, access is made to the application program starting information 250 (FIG. 5) and the starting command 257 corresponding to the object application program in question is executed. Then, the corresponding starting identifying logic 259 is executed to confirm the starting of the object application program. If it is judged that the starting of the object application program has been normally completed, the processing according to the present invention is ended, while if it is judged that the starting of the object application program has not been completed normally, re-trial is made (step 419). In the event of failure of the re-trial, an error display is made and the processing is ended (steps 421 and 417).

Advantages of the Invention

According to the present invention, as set forth above, by merely performing simple operations it is possible to make preparations for an application program packaging environment and execute the application program.

In one aspect of the present invention, even if a user does not have a detailed knowledge of the computer, all that is required is merely performing simple operations, whereby it is possible to introduce a predetermined application program present in a network into a predetermined place and execute and utilize the application program.

In another aspect of the present invention, an applet with signature is used only at the time of starting an application program, and after acquisition and introduction of the application program from the server, the application program, which can be executed locally, is started, thus permitting easy and fast starting of the application program.

1. A method for starting an application program loaded from a server on a client machine, comprising the steps of:
(a) loading an execution environment identifying applet from the server in response to an application program starting request made on the client machine;
(b) loading, from the server, a code that the application program to be started on the client machine requires and a starting command for starting the application program, on the basis of a result obtained by of executing the execution environment identifying applet; and
(c) executing the starting command on the client machine and starting the application program.

2. A method for starting an application program loaded from a server on a client machine, comprising the steps of:
(a) loading, from the server, a code that the application program to be started on the client machine requires and a starting command for starting the application program, in response to an application program starting request made on the client machine; and
(b) executing the starting command on the client machine and starting the application program.

3. The method according to claim 2,
further comprising the step of judging whether the code which the application program requires is present or not on the client machine,
wherein, with respect to the code which the application program requires and the starting command for starting the application program, the code which the application program requires is loaded from the server when the code which the application program requires is not present on the client machine.

4. A software product for starting an application program loaded from a server on a client machine, comprising:
(a) an execution environment identifying software for identifying an execution environment from the server in response to an application program starting request made on the client machine;
(b) a required code acquiring software for acquiring a code which the application program to be started on the client machine requires; and
(c) an application program starting software for executing a starting command for starting the application program on the client machine and thereby starting the application program.

5. A software product for starting an application program loaded from a server on a client machine, comprising:
(a) a required code acquiring software for loading from the server a code which the application program to be started on the client machine requires and a starting command for starting the application program, in response to an application program starting request made on the client machine; and
(b) an application program starting software for executing the starting command on the client machine and starting the application program.

6. The software product according to claim 5, wherein the required code acquiring software has a function of judging whether the code which the application program requires is present or not on the client machine.
